(19) United States
(12) Patent Application Publication
(10) Pub. No.: US 2010/0266329 A1
(43) Pub. Date: Oct. 21, 2010

(54) Device for Applying Substances Contained In An Aerosol

(76) Inventor: Vicente Blasco Feo, Valencia (ES)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/746,376

(22) PCT Filed: May 26, 2008
(86) PCT No.: PCT/ES2008/000371

§ 371 Date: Jun. 4, 2010

(30) Foreign Application Priority Data
Dec. 5, 2007 (ES) U200702585

(51) Int. Cl. B43M 11/06

(52) U.S. Cl. 401/261

(57) ABSTRACT

“The invention relates to a device designed to be attached to the upper part of an aerosol can which contains the substance to be applied, in which a tear-shaped sponge is solidly connected to one of the sides of the device in order to improve the application. A hole extends through the sponge, into which the substance to be applied is discharged. According to the invention, when the sponge or pad is not in use, it is covered with a cap having an internally secured pin that is housed in the above-mentioned through-hole so that the cap can be easily attached, thereby preventing any substance remaining in the through-hole from obstructing same.”

This invention, as its name implies, relates to a device for applying footwear-cleaning substances that are contained in an aerosol.

The object of the invention consists in a device that is designed to be fixed onto the upper portion of the aerosol container containing the substance to be applied, said device having a teardrop-shaped sponge attached to one of its sides that favours application, said sponge being pierced by a through hole through which the substance to be applied is expelled.

The field of the art for this invention is that of articles for cleaning surfaces.

### BACKGROUND OF THE INVENTION

Several different applicators for cleaning substances have been developed within the field of surface cleaning, specifically in the cleaning of footwear.

Within the field of cleaning substances contained in an aerosol we can mention the references of patent ES2041331, relating to an applicator for liquids that can be coupled to containers that consists of two cylindrical surfaces that overlap and are coupled onto the outlet valve of the aerosol bottle and the neck of the container itself, on the top end of which, on the axis of the valve, there is a sponge installed that becomes soaked in the substance when the valve opens as the entire applicator moves by pressure.

There is a similar solution disclosed in utility model U9402064 and patent ES2132696, although in this case the device consists in two cylindrical components wherein the lower component is fixed onto the neck of the aerosol, the top component having a smaller diameter and pressing the aerosol valve in its downward motion, thus releasing the substance that soaks a sponge located upon the axis of said valve.

In the three cases mentioned the sponge is centred upon the axis of the container, and its upper plane coincides with the outlet valve of the fluid.

This configuration of the device necessarily links the release of cleaning fluid with the pressure exerted on the entire assembly, during cleaning operations, for example, such that the user cannot press upon the surface to be cleaned without releasing fluid, even when no more fluid is necessary, neither can the user release fluid if it is not by pressure upon the assembly.

On the other hand, the position and configuration of the sponge in these devices makes them soak in cleaning substances from the inside outwards, via the cavities and channels of the sponge itself, which can easily become saturated, preventing the passage of further cleaning substance towards the surface, unless a very liquid substance is used, which could in turn lead to problems of dripping or spills.

### DESCRIPTION OF THE INVENTION

In order to solve the problems described above, this invention consists in a device that is fixed to the upper portion of an aerosol bottle containing the substance to be applied, where a pad is incorporated on one side of the device, which pad is pierced by a through hole that coincides with the output path of the cleaning substance.

In order to press the output valve, the device has a hinged part, which in its downward path when pressed by the user causes the opening of the valve, releasing the substance contained in the aerosol.

Once the substance to be applied has been released, it goes through a small cannula that releases the substance into the through hole performed in the side pad, such that the release pressure favours the arrival of the substance at the outer surface of said pad.

The pad as designed is shaped as a teardrop in order to facilitate, at the sharper end, access to certain corners and gaps, and at the broader end, fast application in larger areas.

In order to improve the preservation of the sponge or pad and prevent it from soiling when not in use, the invention has a cap that is attached by pressure onto the pad and incorporates a pin that will be housed in the aforementioned through hole, therefore preventing the substance from drying inside and obstructing the hole.

The configuration of the invention facilitates its use, since from the point of view of ergonomics, holding the object with one hand and holding the forefinger over the hinged flexible part, which is the recommended position for use, the pad lies at a position relative to the hand that allows total control, even with fast movements, as well as the easy application of strength upon it.

### BRIEF DESCRIPTION OF THE DRAWINGS

FIG. 1 shows an exploded perspective view of the device and its relative position with respect to the bottle containing the substance to be applied, showing the part (1), which is fixed to the aerosol bottle (2), the teardrop-shaped sponge or pad (3) with a through hole going through (4) and the protector (5) that covers the pad and incorporates a pin (6) that is intended to be housed in the aforementioned through hole.

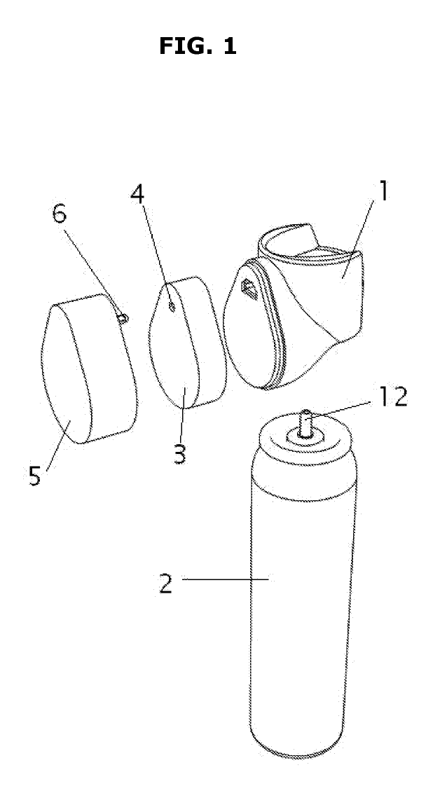

FIG. 2 shows an exploded lower perspective view of the device, also showing the protector (5) with the pin (6) intended to be housed in the through hole, (4) of the pad (3) and showing in detail the circular shape of the bottom of the part (7) intended to be fixed onto the aerosol bottle, the hinged element (8), the part intended to press the aerosol (9) output valve and the output cannula for the substance contained in the bottle (10).

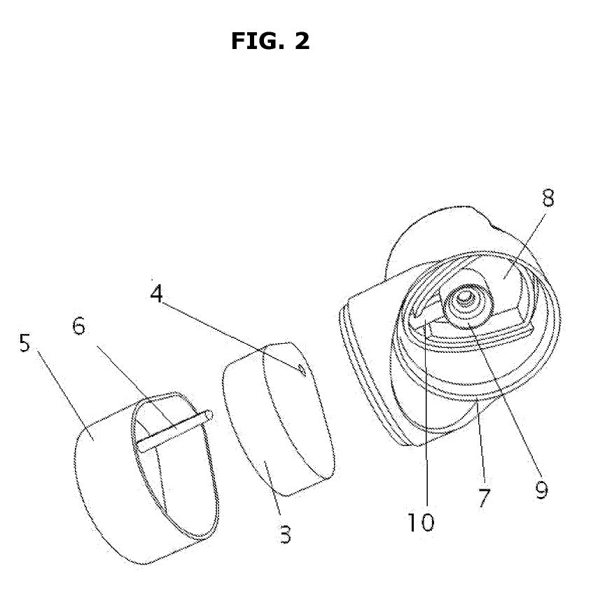

FIG. 3 shows a rear perspective view of the device showing the protector (5) with the pin (6) and the pad (3) and also the hinged surface (11) of the device.

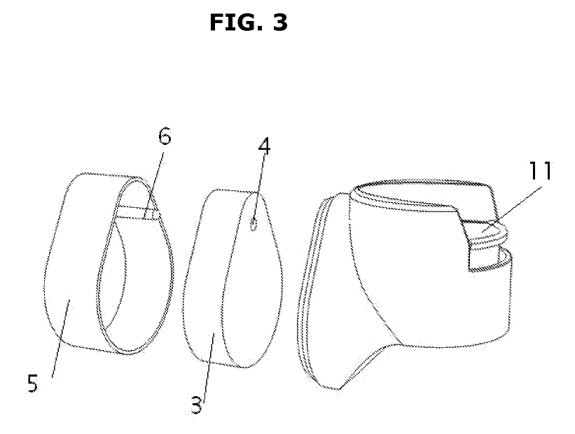

### DESCRIPTION OF A PREFERRED EMBODIMENT OF THE INVENTION

We shall now describe an embodiment of the invention understanding that its scope of protection shall extend to other different embodiments as long as they include the essential components described herein.

The invention consists in a device for the application of substances contained in an aerosol bottle wherein its essential components are a part (1) that is integrally joined to the aerosol bottle (2) itself, said part having fixing elements (7), a hinged area (8) and (11) on the inner side of which there is an essentially cylindrical hollow part (9) with certain inner reliefs that is intended to act, in its downward path, upon the aerosol valve (12), thus releasing the substance contained inside, which then moves outwards via a cannula (10) that ends in a through hole (4) performed on a pad (3) fixed to one side of the device, said pad being protected, when not in use, by a protective cap (5) that includes a pin (6) that is intended to be housed in the through hole (4) described above.

The main part (1) is assembled onto the aerosol bottle (2) such that the essentially cylindrical hollow extension (9) of the bottom part of the hinged element (8) and (11) is coupled onto the aerosol valve (12), but without pressing upon it.

When pressure is exerted upon said hinged element (11), the cylindrical extension moves, causing the opening of the valve and releasing the substance contained in the bottle, which, as a result of the pressure which it is released, reaches the surface of the pad (3), travelling through the cannula (10) that extends between the valve and the pad and the through hole (4) that goes through said pad.

The aforementioned pad has the shape of a teardrop, thus favouring the application of the substance in areas of difficult access by using its sharper end, as well as fast application in larger areas thanks to its broader.

In order to protect the pad during periods when it is not in use, a protector (5) has been incorporated that includes a pin (6) that is inserted into the through hole (4) thus achieving on the one hand the better fixing of the protector to the pad, and on the other hand keeping the through hole in good conditions for use.

1. A DEVICE FOR APPLYING SUBSTANCES CONTAINED IN AN AEROSOL of the type consisting of a part fixed onto an aerosol bottle and including a pad that is soaked in order to favour application of the substance, essentially characterised in that the pad (3), one of the ends of which is narrower than the other, is in a lateral position, with a through hole (4) going through its upper part, which faces a cannula (10) that channels the output of the substance in the aerosol (2) when the valve (12) is pressed by an essentially cylindrical hollow part (9) housed within the lower part of a hinged part (8) and (11) that is integrated into the main part (1) fixed on the aerosol bottle, where said pad has a protective element (5) or cap inside of which there is a pin (6) that coincides with the through hole (4) in the pad (3) such that when said protector is placed on the device, the pin is housed within said through hole, the length of both elements, the pin and the hole, being essentially the same.

2. A DEVICE FOR APPLYING SUBSTANCES CONTAINED IN AN AEROSOL according to claim 1, characterised in that the hinged element (8), (11) follows an essentially vertical path that is contrary to the recovery movement of the closing position of the aerosol valve.

3. (canceled)

4. A DEVICE FOR APPLYING SUBSTANCES CONTAINED IN AN AEROSOL according to claim 1, essentially characterised in that the pad (3) has a surface with one end, preferably the upper end, narrower than the other and ending at a sharp angle, whereas the rest is notably wider and of a more even width.

5. A DEVICE FOR APPLYING SUBSTANCES CONTAINED IN AN AEROSOL according to claims 1 and 3, essentially characterised in that the pad (3) has a through hole that coincides at one end with the end of the cannula (10).

6. A DEVICE FOR APPLYING SUBSTANCES CONTAINED IN AN AEROSOL according to claim 1, essentially characterised in that the hinged part (11) has a surface that is greater than that of the fingertip of an adult's forefinger.
